(19) United States
(12) Patent Application Publication
(10) Pub. No.: US 2013/0106063 A1
(43) Pub. Date: May 2, 2013

(54) Multi-Layer Inserts for Gaskets

(71) Applicant: David J. Schweiger, Pewaukee, WI (US)

(72) Inventor: David J. Schweiger, Pewaukee, WI (US)

(73) Assignee: DANA AUTOMOTIVE SYSTEMS GROUP, LLC, Maumee, OH (US)

(21) Appl. No.: 13/287,605

(22) Filed: Nov. 2, 2011

(51) Int. Cl. F02F 11/00; B23P 11/00

(52) U.S. Cl. 277/591; 29/888.3

(57) ABSTRACT

A multi-layer insert for a gasket having a resilient retention tab having a first position and a second position is provided. The multi-layer insert includes a first plate, a second plate having the resilient retention tab formed therein, and a third plate. The first plate and the second plate are coupled to the third plate. The resilient retention tab in the first position extends outwardly from a central planar portion of the second plate and the resilient retention tab in the second position extends over the central planar portion. An indent formed in the first plate and the third plate receives a portion of the resilient retention tab when the resilient retention tab is placed in the second position.

### FIELD OF THE INVENTION

The invention relates to a multi-layer steel insert for a gasket, such as a cylinder head gasket for use in an internal combustion engine.

### BACKGROUND OF THE INVENTION

A cylinder head gasket for an internal combustion engine seals a joint formed between a cylinder head and a cylinder block. The cylinder block has a plurality of openings formed therein, which include cylinder bores, fluid passages, fastener apertures, and the like. Fluctuations in temperature and pressure within the joint can result in alternating stresses and motions. Depending on the location of each of the openings in the cylinder block, the alternating stresses and motions can create a significant sealing challenge.

Traditionally, a gasket including a molded rubber insert is used to seal fluid passages that are exposed to a light loading or exposed to high lift-off forces. However, in many applications the molded rubber insert cannot adequately conform to the cylinder head and the cylinder block as a result from temperature fluctuations or mechanical motion. Additionally, prolonged exposure to fluids such as coolant, water, and oil, as well as additives or contaminants within such fluids leads to a degradation of the material properties of the molded rubber insert or causes compression set of the molded rubber insert. As a result, a sealing stress applied by the molded rubber insert is significantly reduced.

In view of the foregoing disadvantages of the prior art, it would be advantageous for a gasket to have an insert that can accommodate stresses applied by the cylinder head and the cylinder block as a result of temperature fluctuations and mechanical motion while maintaining a desired seal therebetween. Further, it would be advantageous for the insert for the gasket to minimize compression set or relaxation often seen in prior art designs, to provide improved wear resistance, to provide improved fluid and temperature resistance, to provide improved recovery characteristics, and to provide an improved seal.

### SUMMARY OF THE INVENTION

Provided by the invention, a gasket able to resist thermal motion damage, militate against compression set, and militate against relaxation, has surprisingly been discovered.

In one embodiment, the invention is directed towards a multi-layer insert for a gasket including a first plate and a second plate. The first plate has an inner peripheral edge defining an aperture therethrough. The second plate has an inner peripheral edge defining an aperture therethrough and an outer peripheral edge defining at least one resilient retention tab and substantially defining a second plate profile. Each resilient retention tab has a first portion and a second portion. The first portion is noncoplanar with the second plate and extends towards the first plate and the second portion is noncoplanar with the first portion. The first plate and the second plate are fixed with respect to one another and the each resilient retention tab in the first position extends outwardly from the second plate profile and each resilient retention tab in the second position is within the second plate profile.

In another embodiment, the invention is directed towards a method for securing a multi-layer insert to a cylinder head gasket. The method comprises the steps of providing a first plate having an inner peripheral edge defining an aperture through the first plate and at least two first plate indents, providing a second plate having an inner peripheral edge defining an aperture therethrough and an outer peripheral edge defining at least two resilient retention tabs and at least two fixed retention tabs, the outer peripheral edge substantially defining a second plate profile, the resilient retention tabs having a first portion and a second portion, the first portion noncoplanar with the second plate and extending towards the first plate and the second portion noncoplanar with the first portion, providing a third plate having an inner peripheral edge defining an aperture therethrough and an outer peripheral edge defining at least two third plate indents, coupling the first plate and the second plate to the third plate to form the multi-layer insert having an insert profile, each of the third plate indents substantially aligned with one of the first plate indents to form at least two multi-layer indents and each of the resilient retention tabs substantially aligned with one of the multi-layer indents, providing the cylinder head gasket having a gasket edge at least partially corresponding to the insert profile, placing each of the resilient retention tabs in a position within the insert profile of the multi-layer insert by elastically deforming each of the resilient retention tabs, abuttingly disposing the multi-layer insert against the gasket edge, the at least two fixed retention tabs disposed against a first facial surface of the cylinder head gasket and extending past the gasket edge, and releasing each of the resilient retention tabs from the position within the insert profile of the multi-layer insert, wherein each of the resilient retention tabs returns to an undeformed position, each of the resilient retention tabs extending from the insert profile of the multi-layer insert in the undeformed position, each of the resilient retention tabs disposed against a second facial surface of the cylinder head gasket and extending past the gasket edge to couple the multi-plate insert to the cylinder head gasket.

### BRIEF DESCRIPTION OF THE DRAWINGS

The above, as well as other advantages of the invention will become readily apparent to those skilled in the art from the following detailed description when considered in the light of the accompanying drawings in which:

FIG. 1 is a top view of a gasket including three multi-layer inserts according to an embodiment of the invention;

FIG. 2 is an exploded perspective view of one of the multi-layer inserts shown in FIG. 1;

FIG. 3 is a perspective view of one of the multi-layer inserts shown in FIG. 1;

FIG. 4 is a detail view of a resilient retention tab of the multi-layer inserts shown in FIG. 3, the resilient retention tab in a first position;

FIG. 5 is a detail view of a resilient retention tab of the multi-layer inserts shown in FIG. 3, the resilient retention tab in a second position;

FIG. 6 is a cross-sectional view of the multi-layer insert shown in FIG. 3, the cross-sectional view taken along line 6-6; and

FIG. 7 is a cross-sectional view of the multi-layer insert according to an alternate embodiment of the invention, the cross-sectional view similar to the view shown in FIG. 6.

### DETAILED DESCRIPTION OF THE PREFERRED EMBODIMENTS

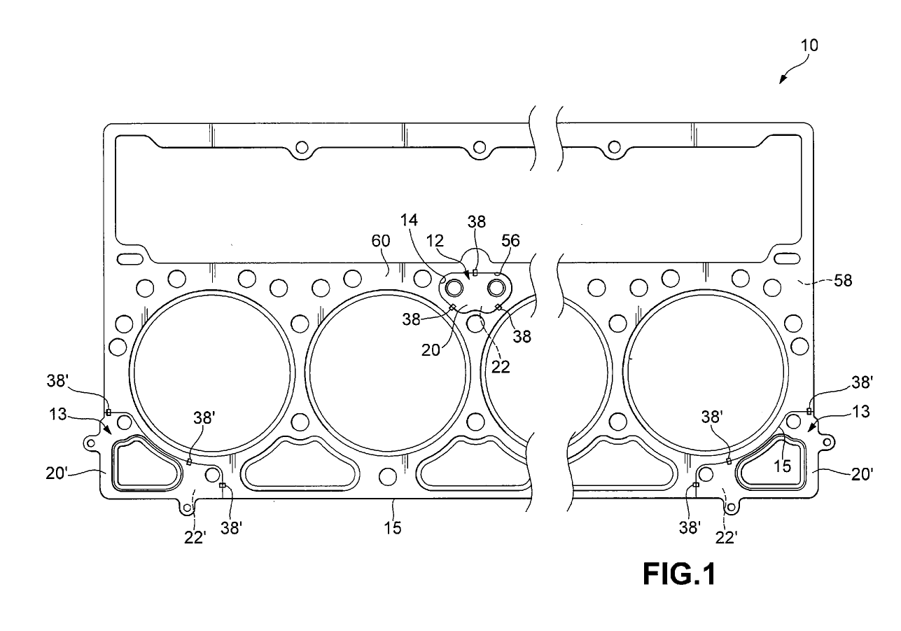

FIG. 1 illustrates a gasket 10 according to an embodiment of the invention. The gasket 10 is typically situated between a cylinder head and a cylinder block, however, it is understood the gasket 10 may be utilized in other applications. The gasket 10 may be made from metal, a composite material, or a combination of the two. The gasket 10 as shown is manufactured in accordance with the shapes of an engine block and an engine head, and includes numerous openings, such as fluid openings for coolant and oil, bolt holes and openings for cylinder bores. As is known in the art, the gasket 10 may be a multi-layer gasket having steel backed graphite layers bonded to opposing sides of a steel reinforcing core.

As shown in FIG. 1, the gasket 10 includes a multi-layer insert 12 and two edge multi-layer inserts 13. Each of the inserts 12, 13 are abuttingly disposed against and coupled to the gasket 10. As shown, the multi-layer insert 12 is disposed against an inner edge 14 of the gasket 10 and two edge multi-layer inserts 13 are disposed against an outer edge 15 of the gasket 10 to form a gasket corner. Each of the inserts 12, 13 is shaped to correspond to a portion of one of the inner edge 14 and the outer edge 15 of the gasket 10. It is understood that any number and any combination of inserts 12, 13 may be disposed against and coupled to the gasket 10. The multi-layer insert 12 preferably defines at least one fluid passage therethrough. The at least one fluid passage may include at least one of a coolant passage and a lubricant passage. Alternately, where the multi-layer insert 12 is used as a load limiter or for other such purposes, it is understood the multi-layer insert 12 may not define at least one fluid passage therethrough. Further, as shown in FIG. 1, the edge multi-layer insert 13 is disposed against the outer edge 15 of the gasket 10 to form a gasket corner, it is contemplated that the edge multi-layer insert 13 include fastener apertures formed therein. When the gasket 10 is a multi-layer gasket, it is understood a portion of the steel backed graphite layers may be removed to facilitate coupling of the multi-layer insert 12 and the edge multi-layer insert 13 to the gasket 10.

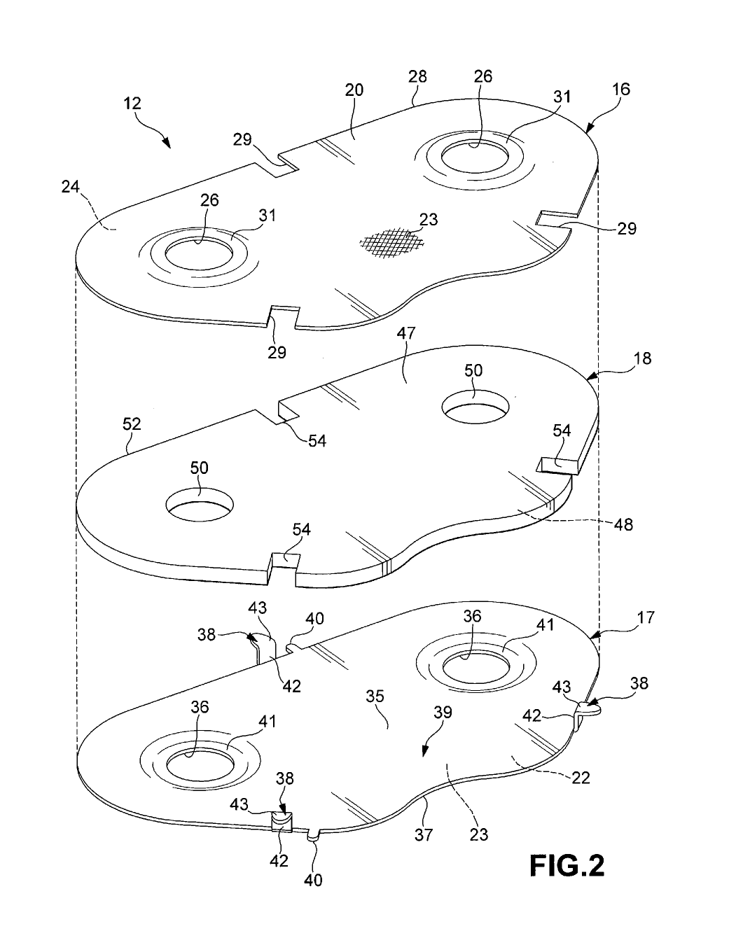

FIGS. 2, 3, 4, and 5 illustrate the multi-layer insert 12. The multi-layer insert 12 includes a first plate 16, a second plate 17, and a third plate 18. It is understood that the multi-layer insert may include any other number of plates. Each of the plates 16, 17, 18 is unitarily formed from a steel in a stamping operation or a plurality of stamping operations. However the plates 16, 17, 18 may be formed from other metals using any other process. Further, each of the plates 16, 17, 18 may be formed from a plurality of pieces coupled together. Preferably, the first plate 16 and the third plate 18 are formed from a stainless steel and may include a coating disposed on a first plate outer surface 20 and a second plate outer surface 22. Further, it is understood that any of the features and characteristics of the multi-layer insert 12 may be applied to the edge multi-layer insert 13.

The first plate 16 includes the first plate outer surface 20, a first plate inner surface 24, a first plate inner peripheral edge 26, a first plate outer peripheral edge 28, at least one first plate indent 29, and at least one first plate half bead 31.

The first plate outer surface 20 has a coating 23 disposed thereon and the first plate outer surface 20 may be prepared to facilitate an application of the coating 23 thereto. As a non-limiting example, an elastomeric coating, such as silicone, NBR, SBR, EPDM, FKM, or others may be applied to the first plate outer surface 20. Alternately, other materials may also be used or no coating may be applied to the first plate outer surface 20.

The first plate inner surface 24 may have an adhesive disposed thereon and the first plate inner surface 24 may be prepared to facilitate an application of the adhesive thereto. As a non-limiting example, a rubber adhesive may be applied to the first plate inner surface 24. It is understood, however, that other adhesives may also be used.

Further, it is also understood that the plates 16, 17, 18 may be coupled to one another using at least one eyelet, at least one rivet, a form-locked engagement, a shear-locked engagement, at least one spot weld, or any other appropriate mechanical coupling.

The first plate inner peripheral edge 26 defines an aperture through the first plate 16. As shown, the first plate 16 includes two first plate inner peripheral edges 26 defining two circular apertures therethrough. However, it is understood that the first plate 16 may include fewer or more first plate inner peripheral edges 26 defining apertures of any shape.

The first plate outer peripheral edge 28 defines a first plate profile. As shown, the first plate outer peripheral edge 28 defines three first plate indents 29; however, it is understood that the first plate 16 may include any number of first plate indents 29.

Each of the first plate indents 29 is substantially rectangular in shape and includes rounded corners; however, it is understood that the first plate indents 29 may be any shape. Preferably, the first plate 16 is formed from a steel in a stamping process. Alternately, the first plate 16 may be formed from other metals. The first plate outer peripheral edge 28 including the first plate indents 29 corresponds to a first plate profile. As shown, the first plate indents 29 are spaced equidistantly about the first plate outer peripheral edge 28; however the first plate indents 29 may be arranged depending on a shape of the multi-layer insert 12 or the fastening requirements of the multi-layer insert 12.

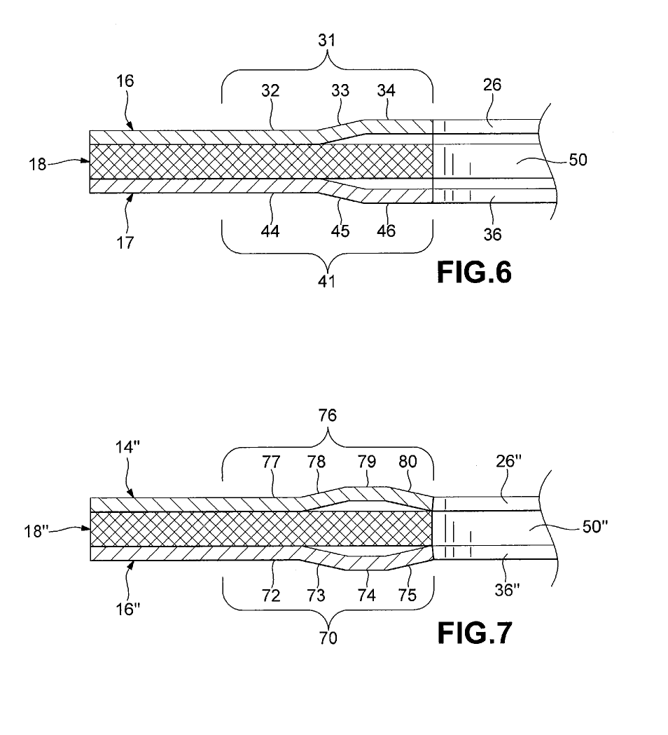

The first plate half beads 31are formed adjacent the first plate inner peripheral edges 26. One of the first plate half beads 31 is shown in FIG. 6. The first plate half bead 31 is unitarily formed with the first plate 16 and includes a first planar portion 32, a first ramp portion 33, and a second planar portion 34. It is understood the first plate half beads 31 may be formed in either direction with respect to the third plate 18, where a direction of the first plate half beads 31 may be dependent on a number of layers of the multi-layer insert 12.

The first planar portion 32 is a portion of the first plate 16 located outwardly from each of the first plate inner peripheral edges 26. The first ramp portion 33 is a portion of the first plate 16 oblique to the first planar portion 32 located outwardly from each of the first plate inner peripheral edges 26 and inwardly from each of the first planar portions 32. As shown in FIG. 6, the first ramp portion 33 extends away from the third plate 18. The first ramp portion 33 may be formed in the first plate 16 during the stamping operation used to form the first plate 16 or may be formed in a secondary operation after the stamping operation used to form the first plate 16.

The second planar portion 34 is a portion of the first plate 16 parallel to the first planar portion 32 located inwardly from each of the first ramp portions 33. As shown in FIG. 6, the second planar portion 34 is noncoplanar with the first planar portion 32. The second planar portion 34 may be formed in the first plate 16 during the stamping operation used to form the first plate 16 or may be formed in a secondary operation after the stamping operation used to form the first plate 16.

The second plate 17 includes the second plate outer surface 22, a second plate inner surface 35, a second plate inner peripheral edge 36, a second plate outer peripheral edge 37, at least one resilient retention tab 38, a central planar portion 39, at least one fixed retention tab 40, and at least one second plate half bead 41.

The second plate outer surface 22 may have a coating disposed thereon and the second plate outer surface 22 may be prepared to facilitate an application of the coating thereto. As a non-limiting example, an elastomeric coating, such as silicone, NBR, SBR, EPDM, FKM, or others may be applied to the first plate outer surface 20. Alternately, other materials may also be used or no coating may be applied to the first plate outer surface 20.

The second plate inner surface 35 may have an adhesive disposed thereon and the second plate inner surface 35 may be prepared to facilitate an application of the adhesive thereto. As a non-limiting example, a rubber adhesive may be applied to the second plate inner surface 35. It is understood, however, that other adhesives may also be used. Further, it is also understood that the plates 16, 17, 18 may be coupled to one another using at least one eyelet, at least one rivet, a form-locked engagement, a shear-locked engagement, at least one spot weld, or any other appropriate mechanical coupling.

The second plate inner peripheral edge 36 defines an aperture through the second plate 17. As shown, the second plate 17 includes two second plate inner peripheral edges 36 defining two circular apertures therethrough. However, it is understood that the second plate 17 may include fewer or more second plate inner peripheral edges 36 defining apertures of any shape.

The second plate outer peripheral edge 37 defines three resilient retention tabs 38 and three fixed retention tabs 40; however, it is understood that the second plate 17 may include any number of the resilient retention tabs 38 and the fixed retention tabs 40.

The resilient retention tabs 38 are elongate protuberances unitarily formed with the second plate 17 and each have a first portion 42 and a second portion 43. As shown, the resilient retention tabs 38 are spaced equidistantly about the second plate outer peripheral edge 37; however the resilient retention tabs 38 may be arranged depending on a shape of the multi-layer insert 12 or the fastening requirements of the multi-layer insert 12. The resilient retention tabs 38 each have a first position and a second position. As shown in FIGS. 1-4, the resilient retention tabs 38 are in a first position. As shown in FIG. 5, the resilient retention tabs 38 are in a second position.

The first portion 42 of each of the resilient retention tabs 38 is formed noncoplanar to the second plate 17. As most clearly shown in FIGS. 2 and 4, when each of the resilient retention tabs 38 is in the first position, the first portion 42 is substantially perpendicular to the second plate 17 and each of the resilient retention tabs 38 extends outwardly from the second plate 17. Alternately, the first portion 42 may be formed obliquely to the second plate 17 or the first portion 42 may be an arcuate portion of each of the resilient retention tabs 38.

The second portion 43 of each of the resilient retention tabs 38 is formed noncoplanar to the first portion 42. As most clearly shown in FIGS. 2 and 4, when each of the resilient retention tabs 38 is in the first position, the second portion 43 is substantially perpendicular to the first portion 42 and substantially coplanar with the first plate 16. Alternately, the second portion 43 may be formed obliquely to the first portion 42, may be non-coplanar with the first plate 16, or may be an arcuate portion of each of the resilient retention tabs 38.

The central planar portion 39 of the second plate 17 is a planar body substantially defined by the second plate inner surface 35 and the second plate outer surface 22. The central planar portion 39 is substantially defined by the second plate outer peripheral edge 37; however, the central planar portion 39 does not include the resilient retention tabs 38, the fixed retention tabs 40, the second plate half beads 41, and the second plate inner peripheral edges 36.

The fixed retention tabs 40 are elongate protuberances unitarily formed and coplanar with the second plate 17 and extending from the second plate outer peripheral edge 37. Each of the fixed retention tabs 40 has a thickness equal to a thickness of the second plate 17. As shown, each of the fixed retention tabs 40 has a rounded distal end; however it is understood that each of the fixed retention tabs 40 may include distal ends having any other shape. Further, it is understood that the fixed retention tabs 40 may be formed separate the second plate 17 and attached thereto in any conventional manner, that the fixed retention tabs 40 may be non-coplanar with the second plate 17, and that the fixed retention tabs 40 may be any thickness. As shown, the fixed retention tabs 40 are spaced equidistantly about the second plate outer peripheral edge 37; however the fixed retention tabs 40 may be arranged depending on a shape of the multi-layer insert 12 or the fastening requirements of the multi-layer insert 12.

The second plate half beads 41 are formed adjacent the second plate inner peripheral edges 36. One of the second plate half beads 41 is shown in FIG. 6. The second plate half bead 41 is unitarily formed with the second plate 17 and includes a first planar portion 44, a first ramp portion 45, and a second planar portion 46. The first planar portion 44 is a portion of the second plate 17 located outwardly from each of the second plate inner peripheral edges 36. The first ramp portion 45 is a portion of the second plate 17 oblique to the first planar portion 44 located outwardly from each of the second plate inner peripheral edges 36 and inwardly from each of the first planar portions 44. As shown in FIG. 6, the first ramp portion 45 extends away from the third plate 18. The first ramp portion 45 may be formed in the second plate 17 during the stamping operation used to form the second plate 17 or may be formed in a secondary operation after the stamping operation used to form the second plate 17. The second planar portion 46 is a portion of the second plate 17 parallel to the first planar portion 44 located inwardly from each of the first ramp portions 45. As shown in FIG. 6, the second planar portion 46 is noncoplanar with the first planar portion 44. The second planar portion 46 may be formed in the second plate 17 during the stamping operation used to form the second plate 17 or may be formed in a secondary operation after the stamping operation used to form the second plate 17. It is understood the second plate half beads 41 may be formed in either direction with respect to the third plate 18, where a direction of the second plate half beads 41 may be dependent on a number of layers of the multi-layer insert 12.

The third plate 18 includes a first outer surface 47, a second outer surface 48, a third plate inner peripheral edge 50, a third plate outer peripheral edge 52, and at least one third plate indent 54. As shown, a thickness of the third plate 18 is about twice as thick as a thickness of the first plate 16 and the second plate 17; however, it is understood that the third plate 18 may be of any thickness. The thickness of the third plate 18 rigidizes the multi-layer insert 12; however, the thickness of the multi-layer insert 12 may be varied to create other desirable characteristics. Preferably, the third plate 18 is formed from a steel in a stamping process. Alternately, the third plate 18 may be formed from other metals using any other process.

The first outer surface 47 may have an adhesive disposed thereon and the first outer surface 47 may be prepared to facilitate an application of the adhesive thereto. The second outer surface 48 may have an adhesive disposed thereon and the second outer surface 48 may be prepared to facilitate an application of the adhesive thereto. As a non-limiting example, a rubber adhesive may be applied to the first outer surface 47 and the second outer surface 48. It is understood, however, that other adhesives may also be used. Further, it is also understood that the plates 16, 17, 18 may be coupled to one another using at least one eyelet, at least one rivet, a form-locked engagement, a shear-locked engagement, at least one spot weld, or any other appropriate mechanical coupling.

The third plate inner peripheral edge 50 defines an aperture through the third plate 18. As shown, the third plate 18 includes two third plate inner peripheral edges 50 defining two circular apertures therethrough, each of the third plate inner peripheral edges 50 substantially corresponds to the first plate inner peripheral edges 26 and the second plate inner peripheral edges 36. However, it is understood that the third plate 18 may include fewer or more third plate inner peripheral edges 50 defining apertures of any shape.

The third plate outer peripheral edge 52 corresponds to a third plate profile. As most clearly shown in FIG. 2, the third plate outer peripheral edge 52 defines three third plate indents 54; however, it is understood that the third plate 18 may include any number of third plate indents 54. Each of the third plate indents 54 is substantially rectangular in shape and includes rounded corners; however, it is understood that the third plate indents 54 may be any shape. As shown, the third plate indents 54 are spaced equidistantly about the third plate outer peripheral edge 52 and substantially correspond to the first plate indents 29; however the third plate indents 54 may be arranged depending on a shape of the multi-layer insert 12 or the fastening requirements of the multi-layer insert 12.

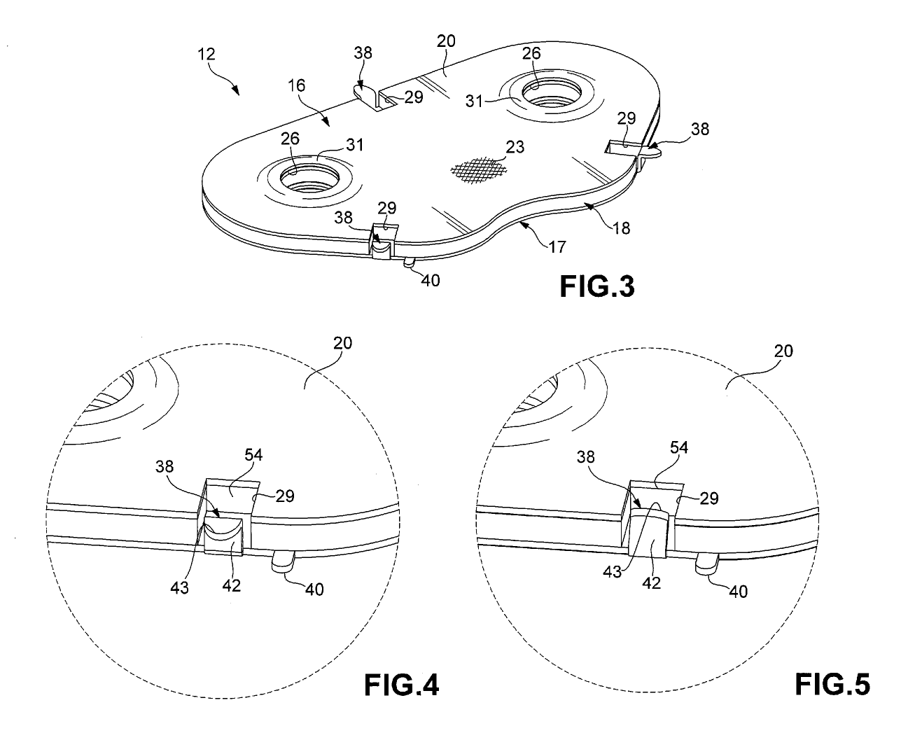

The first plate 16, the second plate 17, and the third plate 18 are coupled together to form the multi-layer insert 12. In anticipation of coupling, the first plate profile and the second plate profile are aligned with the third plate profile. As such, the first plate inner peripheral edges 26 and the second plate inner peripheral edges 36 are respectively aligned with each of the third plate inner peripheral edges 50 to form a portion of a fluid conduit. The first plate indents 29 are respectively aligned with each of third plate indents 54 when the first plate 16 is aligned with the third plate 18, as most clearly shown in FIGS. 3, 4, and 5. Similarly, the resilient retention tabs 38 are respectively aligned with each of third plate indents 54 when the second plate 17 is aligned with the third plate 18, as most clearly shown in FIGS. 3, 4, and 5.

After application of the adhesive to at least one of the first plate inner surface 24, the second plate inner surface 35, the first outer surface 47, and the second outer surface 48, the first plate 16 and the second plate 17 are abuttingly disposed against the third plate 18. A force may be applied to the first plate outer surface 20 and the second plate outer surface 22 until the adhesive is cured. Alternately, the first plate 16, the second plate 17, and the third plate 18 may be coupled with a weld, a plurality of welds, or any other fastener conventionally used to couple multi-layer inserts and multi-layer gaskets.

Following assembly of the multi-layer insert 12, the multi-layer insert 12 is coupled to the gasket 10. When the multi-layer insert 12 is disposed in a gasket aperture 56 defined by the inner edge 14 of the gasket 10, the inner edge 14 of the gasket 10 substantially corresponds to a profile of the multi-layer insert 12. When the edge multi-layer insert 13 is disposed against an outer edge 15 of the gasket 10, a portion of the outer edge 15 of the gasket 10 substantially corresponds to a portion of the edge multi-layer insert 13.

Prior to insertion of the multi-layer insert 12 into the gasket aperture 56, the resilient retention tabs 38 are moved from the first position to the second position, the resilient retention tabs 38 in the second position at least partially disposed in the first plate indents 29 and the third plate indents 54 each of the resilient retention tabs 38 are respectively aligned with. Further, each of the resilient retention tabs 38 in the second position extend over the second plate 17. To move the resilient retention tabs 38 from the first position to the second position, a tool (not shown) is pressed against one of the first portion 42 and the second portion 43 of each of the resilient retention tabs 38 and a force is applied thereto in a direction of the first plate indent 29. The force applied causes an elastic deformation of each of the first portions 42, resulting in the resilient retention tabs 38 entering the first plate indent 29 and the third plate indent 54. The tool may move the resilient retention tabs 38 simultaneously or each of the resilient retention tabs 38 may be moved individually.

Once the resilient retention tabs 38 are within the first plate indent 29 and the third plate indent 54, the multi-layer insert 12 is disposed in the gasket aperture 56. The first plate 16 and the third plate 18 enter the gasket aperture 56 and the fixed retention tabs 40 abut a first face 58 of the gasket 10. Typically, a portion of a first face 58 of the gasket 10 corresponding to the fixed retention tabs 40 is removed in preparation of coupling the multi-layer insert 12 to the gasket 10, allowing the first plate outer surface 20 to be substantially coplanar with the first face 58 and the second plate outer surface 22 to be substantially coplanar with a second face 60 of the gasket 10. Alternately, where the gasket 10 includes the first face 58 able to be deformed, an additional force may be applied to the multi-layer insert 12, causing the fixed retention tabs 40 to enter the first face 58 of the gasket 10. Further, it is understood that at least a portion of the second plate outer surface 22 may be temporarily positioned between the first face 58 and the second face 60 by the additional force in anticipation of releasing each of the resilient retention tabs 38 from the second position to the first position.

To secure the multi-layer insert 12 to the gasket 10, the tool is released from each of the second portions 43 or the first portions 42. As a result of the elastic deformation of each of the first portions 42, the resilient retention tabs 38 return to the first position to secure the multi-layer insert 12 to the gasket 10. When the multi-layer insert 12 is secured to the gasket 10 as shown in FIG. 1, the second portion 43 of each resilient retention tab 38 abut the second face 60 of the gasket 10 while each of the fixed retention tabs 40 abut the first face 58 of the gasket.

FIG. 1 illustrates the edge multi-layer insert 13 for a gasket 10. Similar structural features of the multi-layer insert 12 include the same reference numeral and a prime (′) symbol.

Where the edge multi-layer insert 13 is disposed against the outer edge 15 of the gasket 10, the fixed retention tabs (not shown) abut the first face 58 of the gasket 10. Typically, the portion of the first face 58 of the gasket 10 corresponding to the first plate retention tabs is removed in preparation of coupling the edge multi-layer insert 13 to the gasket 10, allowing the first plate outer surface 20′ to be substantially coplanar with the first face 58 and the second plate outer surface 22′ to be substantially coplanar with the second face 60 of the gasket 10. Alternately, where the gasket 10 includes the first face 58 able to be deformed, an additional force may be applied to the edge multi-layer insert 13, causing the first plate retention tabs to enter the first face 58 of the gasket 10. Further, it is understood that at least a portion of the first plate outer surface 20′ may be temporarily positioned between the first face 62 and the second face 64 by the additional force in anticipation of moving each of the resilient retention tabs 38′ from the first position to the second position. To secure the edge multi-layer insert 13 to the gasket 10 the edge multi-layer insert 13 is disposed adjacent against, a tool (not shown) the tool is released from each of the second portions 43 or the first portions 42 in a similar manner to the method described above.

FIG. 7 shows an alternative embodiment of the multi-layer insert 12 for a gasket 10. Similar structural features of the manifold assembly include the same reference numeral and a double prime (“) symbol.

FIG. 7 illustrates second plate whole beads 70 formed adjacent the second plate inner peripheral edges 36”. One of the second plate whole beads 70 is shown in FIG. 7. The second plate whole bead 70 is unitarily formed with the second plate 17″ and includes a first planar portion 72, a first ramp portion 73, a second planar portion 74, and a second ramp portion 75.

The first planar portion 72 is a portion of the second plate 17″ located outwardly from each of the second plate inner peripheral edges 36″. The first ramp portion 73 is a portion of the second plate 17″ oblique to the first planar portion 72 located outwardly from each of the second plate inner peripheral edges 36″ and inwardly from each of the first planar portions 72.

As shown in FIG. 7, the first ramp portion 73 extends away from the third plate 18″. The first ramp portion 73 may be formed in the second plate 17″ during the stamping operation used to form the second plate 17″ or may be formed in a secondary operation after the stamping operation used to form the second plate 17″.

The second planar portion 74 is a portion of the second plate 17″ parallel to the first planar portion 72 located inwardly from each of the first ramp portions 73. As shown in FIG. 7, the second planar portion 74 is noncoplanar with the first planar portion 72. The second planar portion 74 may be formed in the second plate 17″ during the stamping operation used to form the second plate 17″ or may be formed in a secondary operation after the stamping operation used to form the second plate 17″.

The second ramp portion 75 is a portion of the second plate 17″ oblique to the second planar portion 74 located outwardly from each of the second plate inner peripheral edges 36″ and inwardly from the second planar portions 74. As shown in FIG. 7, the second ramp portion 75 extends towards the third plate 18″. The second ramp portion 75 may be formed in the second plate 17″ during the stamping operation used to form the second plate 17″ or may be formed in a secondary operation after the stamping operation used to form the second plate 17″.

FIG. 7 also illustrates a first plate whole bead 76 formed in the first plate 16″ similar to the second plate whole bead 70 including a first planar portion 77, a first ramp portion 78, a second planar portion 79, and a second ramp portion 80.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. A multi-layer insert for a gasket, comprising:
a first plate having an inner peripheral edge defining an aperture therethrough; and
a second plate having an inner peripheral edge defining an aperture therethrough, an outer peripheral edge defining at least one resilient retention tab, and a central planar portion, the at least one resilient retention tab having a first portion and a second portion, the first portion noncoplanar with the second plate and extending towards the first plate and the second portion noncoplanar with the first portion, wherein the first plate and the second plate are fixed with respect to one another and the at least one resilient retention tab in the first position extends away from the central planar portion and a portion of the at least one resilient retention tab in the second position extends over the central planar portion.

2. The multi-layer insert for a gasket according to claim 1, wherein the outer peripheral edge of the second plate defines at least one fixed retention tab.

3. The multi-layer insert for a gasket according to claim 1, wherein half beads are formed adjacent the inner peripheral edges of the first plate and the second plate, each of the half beads comprising a first planar section, a ramp, and a second planar section.

4. The multi-layer insert for a gasket according to claim 1, wherein whole beads are formed adjacent the inner peripheral edges of the first plate and the second plate, each of the whole beads comprising a first planar section, a first ramp section, a second planar section, and a second ramp section.

5. The multi-layer insert for a gasket according to claim 1, wherein an outer surface of the first plate and an outer surface of the second plate each have a coating applied thereto.

6. The multi-layer insert for a gasket according to claim 1, wherein the first plate and the second plate are formed from a stainless steel.

7. The multi-layer insert for a gasket according to claim 1, wherein the outer peripheral edge of the first plate defines at least one first plate indent.

8. The multi-layer insert for a gasket according to claim 1, further comprising a third plate having an inner peripheral edge defining an aperture therethrough and an outer peripheral edge, the first plate and the second plate coupled to the third plate.

9. The multi-layer insert for a gasket according to claim 8, wherein the inner peripheral edges of the first plate, the third plate, and the second plate cooperate to form a portion of a fluid conduit.

10. The multi-layer insert for a gasket according to claim 8, wherein the outer peripheral edge of the third plate defines at least one third plate indent.

11. The multi-layer insert for a gasket according to claim 8, wherein the third plate includes at least two third plate indents, each of the third plate indents substantially aligned with at least two resilient retention tabs formed in the second plate.

12. The multi-layer insert for a gasket according to claim 10, wherein the third plate includes at least two third plate indents and the second plate includes at least two resilient retention tabs, each of the third plate indents substantially aligned with the at least two resilient retention tabs.

13. The multi-layer insert for a gasket according to claim 1, wherein the first portion of the at least one resilient tabs is substantially perpendicular to the second portion of the at least one resilient tab.

14. The multi-layer insert for a gasket according to claim 1, wherein the first portion of the at least one resilient tabs is substantially perpendicular to the second plate when the at least one resilient tab is in the first position.

15. The multi-layer insert for a gasket according to claim 1, wherein the first plate includes at least two first plate indents, each of the first plate indents substantially aligned with at least two resilient retention tabs formed in the second plate.

16. A cylinder head gasket for an internal combustion engine having a multi-layer insert, the multi-layer insert comprising:
a first plate having an inner peripheral edge defining an aperture through the first plate and at least one first plate indent;
a second plate having an inner peripheral edge defining an aperture therethrough, an outer peripheral edge defining at least one resilient retention tab and at least one fixed retention tab, and a central planar portion, the outer peripheral edge substantially defining a second plate profile, the at least one resilient retention tab having a first portion and a second portion, the first portion noncoplanar with the second plate and extending towards the first plate and the second portion noncoplanar with the first portion; and
a third plate having an inner peripheral edge defining an aperture therethrough and an outer peripheral edge defining at least one third plate indent, wherein the first plate and the second plate are coupled to the third plate, the inner peripheral edges of the first plate, the third second plate, and the third plate cooperate to form a portion of a fluid conduit, and the at least one resilient retention tab in the first position extends outwardly from the central planar portion and a portion of the at least one resilient retention tab in the second position extends over the central planar portion and a portion of the at least one resilient retention tab is received by the at least one first plate indent and the at least one third plate indent.

17. The multi-layer insert for a gasket according to claim 16, wherein the first portion of the at least one resilient tabs is substantially perpendicular to the second plate when the at least one resilient tab is in the first position.

18. The multi-layer insert for a gasket according to claim 16, wherein half beads are formed adjacent the inner peripheral edges of the first plate and the second plate, each of the half beads comprising a first planar section, a ramp, and a second planar section.

19. The multi-layer insert for a gasket according to claim 16, wherein whole beads are formed adjacent the inner peripheral edges of the first plate and the second plate, each of the whole beads comprising a first planar section, a first ramp section, a second planar section, and a second ramp section.

20. A method for securing a multi-layer insert to a cylinder head gasket, the method comprising the steps of:
providing a first plate having an inner peripheral edge defining an aperture through the first plate and at least two first plate indents;
providing a second plate having an inner peripheral edge defining an aperture therethrough and an outer peripheral edge defining at least two resilient retention tabs and at least two fixed retention tabs, the outer peripheral edge substantially defining a second plate profile, the resilient retention tabs having a first portion and a second portion, the first portion noncoplanar with the second plate and extending towards the first plate and the second portion noncoplanar with the first portion;
providing a third plate having an inner peripheral edge defining an aperture therethrough and an outer peripheral edge defining at least two third plate indents;
coupling the first plate and the second plate to the third plate to form the multi-layer insert having an insert profile, each of the third plate indents substantially aligned with one of the first plate indents to form at least two multi-layer indents and each of the resilient retention tabs substantially aligned with one of the multi-layer indents;
providing the cylinder head gasket having a gasket edge at least partially corresponding to the insert profile;
placing a portion of each of the resilient retention tabs in a position within the insert profile of the multi-layer insert by elastically deforming each of the resilient retention tabs;
abuttingly disposing the multi-layer insert against the gasket edge, the at least two fixed retention tabs disposed against a first facial surface of the cylinder head gasket and extending past the gasket edge; and
releasing each of the resilient retention tabs from the position within the insert profile of the multi-layer insert, wherein each of the resilient retention tabs returns to an undeformed position, each of the resilient retention tabs extending from the insert profile of the multi-layer insert in the undeformed position, each of the resilient retention tabs disposed against a second facial surface of the cylinder head gasket and extending past the gasket edge to couple the multi-plate insert to the cylinder head gasket.
